(19) United States
(12) Patent Application Publication
(10) Pub. No.: US 2026/0128699 A1
(43) Pub. Date: May 7, 2026

(54) PULSE WIDTH MODULATION SIGNAL GENERATOR AND METHOD

(71) Applicant: Infineon Technologies AG, Neubiberg (DE)

(72) Inventors: Mihail Jefremow, Augsburg (DE); Jürgen Schäfer, Oberhaching (DE); Alberto Trentin, Sopra (IT); Klaus Scheibert, Grasbrunn (DE); Arndt Voigtländer, Antdorf (DE); Michael Augustin, Villach (AT)

(21) Appl. No.: 19/373,853

(22) Filed: Oct. 30, 2025

(30) Foreign Application Priority Data
Nov. 6, 2024 (DE) 102024210674.7

(51) Int. Cl. H02P 23/22; G01D 5/245; G01P 3/489

(52) U.S. Cl. CPC H02P 23/22; G01D 5/245; G01P 3/489

(57) ABSTRACT

A semiconductor device for generating PWM modulation signals, for example an optimized pulse pattern OPP is provided. An ADC 42 outputs the angle of the motor, and is connected to a coprocessor 52 for example a digital signal processor DSP. The coprocessor 52 has an observer 44 connected to the angle inputs for generating a motor angle and a look up table 48 for generating a PWM signal as a direct function of the generated motor angle A PWM signal is output to timer unit 50. A calculating unit 46 has an input connected to the coprocessor 52, the calculating unit being arranged to select a look up table based on the generated motor angle and to store the selected look up table as the look up table 48.

### REFERENCE TO RELATED APPLICATION

This Application claims priority to German Application number 102024210674.7, filed on Nov. 6, 2024, the contents of which are hereby incorporated by reference in their entirety.

### FIELD OF THE INVENTION

The invention relates to a method of generating a pulse width modulation signal and to a semiconductor device for generating the signal, especially for use in driving a motor.

### BACKGROUND OF THE INVENTION

There is a need to efficiently drive electric motors. For example, in the powertrain of an electric or hybrid vehicle, the electric motor is driven from a battery by a number of drivers. Typically, six power transistors arranged as three half bridges are used to drive a three phase electric motor.

The power transistors are driven by signals, typically pulse width modulation signals, i.e. the transistors are either off or on. The power transistors are driven by a driver controlled by a control unit, for example a microcontroller, which generates the signals.

One approach is known as space vector pulse width modulation, PWM. When using this approach, a higher switching frequency allows the generation of a PWM signal with reduced ripple and lower harmonic distortion which allows for lower losses in the motor.

There is a general need for approaches which avoid excessive losses in motors.

### SUMMARY OF THE INVENTION

According to a first example there is provided a semiconductor device for generating a pulse pattern signal, comprising an analog to digital converter, ADC, for connection to a motor, having an output for indicating the angle of the motor, a coprocessor having an angle input connected to the output of the ADC, an observer connected to the angle input for determining a motor angle, a coprocessor look up table for generating a PWM pulse pattern signal as a direct function of the determined motor angle, and a pulse pattern signal output for outputting the pulse pattern signal, and a calculating unit having an input connected to the coprocessor, the calculating unit being arranged to select a look up table from a plurality of look up tables based on the determined motor conditions e.g. like acceleration and torque and to store the selected look up table as the coprocessor look up table in the coprocessor.

By using a look up table in the coprocessor, the example provides a first loop driven directly from the angle measurement; this can deliver a fast loop without requiring complex structures in the semiconductor device.

By generating the pulse pattern signal directly from the analog to digital converter, ADC, output the pulse pattern signal can be delivered as fast as the ADC can deliver a signal. Thus the ADC and DSP deliver a fast loop; the updating of the look up table by the calculating unit constitutes a second, slower outer loop. For example, the fast loop can operate on a timeframe of less than 10 μs, for example less than 2 μs, while the outer loop including the calculating unit can operate on a timeframe of more than 20 μs, for example more than 40 μs. This in turn allows the use of a conventional microcontroller general purpose core to deliver the calculations in the outer loop; alternative embodiments may use alternative hardware for example, an alternative core, for example in a parallel processing unit.

### BRIEF DESCRIPTION OF THE DRAWINGS

Examples of the invention will now be described, purely by way of example, with reference to the accompanying drawings, in which:

FIG. 1 illustrates an example optimized pulse pattern (A) and an example regular pulse pattern (B).

FIG. 2 illustrates example drive signals for a driver together with a driver;

FIG. 3 illustrates an example arrangement;

FIG. 4 illustrates a further example arrangement.

FIG. 5 illustrates example PWM signals;

FIG. 6 illustrates example drive signals;

FIG. 7 illustrates a further example arrangement; and

FIG. 8 illustrates signals corresponding to the arrangement of FIG. 7.

### DETAILED DESCRIPTION

An example of the invention will be presented, purely by way of example.

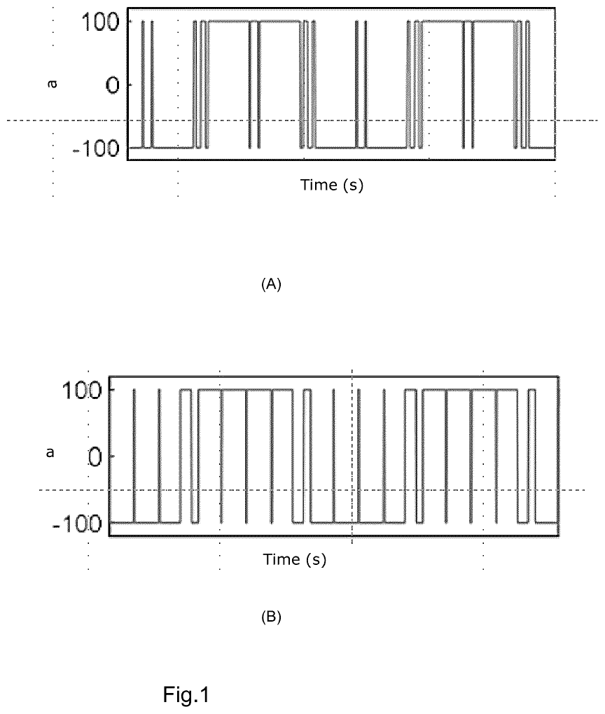

FIG. 1 shows an example of an optimized pulse pattern used to drive a motor (A) and a conventional regular pulse pattern (B). The regular pulse pattern (B) begins pulses at a regular interval and adjusts the length of the pulse to provide pulse width modulation (PWM).

Optimized pulse patterns, OPP, can be used to deliver a signal with lower total harmonic distortion, THD, than space vector pulse width modulation. In such optimized patterns, switching is not constrained to be at regular intervals but at times chosen for lower THD and losses.

For example, an OPP using a switching frequency of 9 kHz may be able to deliver a THD of 2.3%. In contrast, a SVPWM approach with the same switching frequency of 9 kHz may deliver a current signal with a THD of 5.7%. In order for the SVPWM approach to reach a similar THD, 2.35%, the switching frequency needs to be increased to 20 kHz. This higher switching frequency means that the transistors in the half bridge driving the motor are switched more often leading to higher switching losses. Thus, the use of OPP can significantly increase efficiency and hence reduce losses, in turn leading to lower heat generation such that it becomes easier to keep the semiconductors and the motor in a correct temperature range for operation.

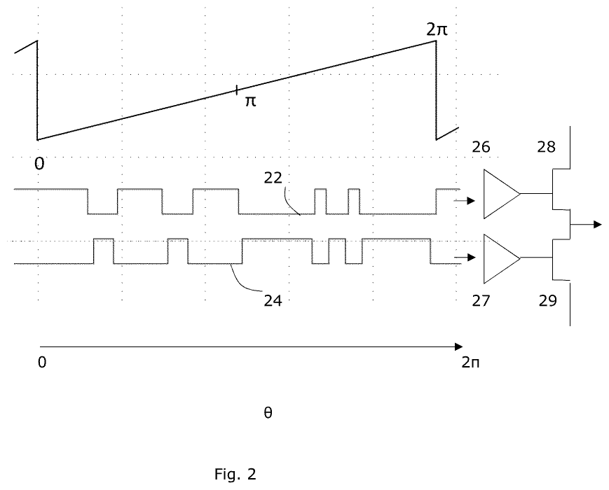

Such OPPs should be generated in synch with the angle position of the motor. Moreover, the OPP requires multiple switching, at least 8 times per revolution. FIG. 2 shows the control signals for a high side and a low side driver as a function of angle. The angle is indicated in line 20, the high side signal at 22 and the low side signal at 24. The signals are fed into a high side driver 26 and a low side driver 27, which in turn feed a high side transistor 28 and a low side transistor 29 illustrated in FIG. 2. Note that the high side and low side signals are not simply inverses of each other: in this example some dead time is introduced to ensure that the high side driver 26 and low side driver 27 are not both on at the same time. As illustrated in FIG. 2, the switching times are not periodic.

Calculating OPP signals requires a significant computing load. In order to avoid the need for excessively high power computing hardware to compute the OPP using software, some hardware functionality may be provided in the microcontroller to obtain the pulse patterns. It may not be possible to carry out all processing at a sufficient speed using software running in a conventional core when using a realistically priced microcontroller.

There is a need for a product which can be used for this application without being complex and expensive, in particular for example avoiding the need for such features as a field programmable gate array and the need for large amounts of high speed memory and hence chip area. There is accordingly a need for a hardware device and a method of generating a pulse pattern signal using a hardware device which does not require such complex elements.

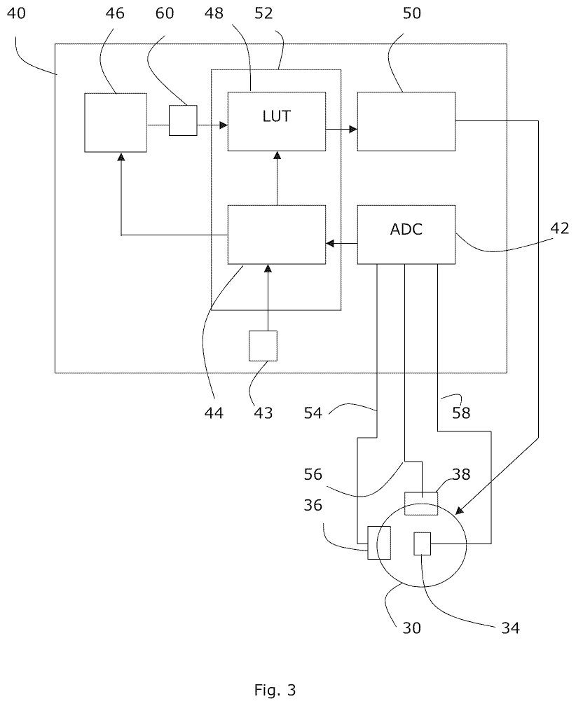

FIG. 3 illustrates an example. A motor 30 is mechanically connected to inductive sensor 36, magnetic sensor 38 and to coil 34. In use, coil 34 is energized by a current in carrier connection 58 and the inductive fields picked up by sensors 36, 38 are used to generate a sine signal on sine connection 54 and a cosine signal on cosine connection 56. Note that although the sensors shown are inductive sensors, other sensors such as for example magnetic sensors or alternative sensors may be used.

A microcontroller 40 is provided having an input ADC 42, an observer 44, a calculating unit 46, a look up table (LUT) 48, and timer unit 50. The observer 44 and look up table 48 are comprised within a coprocessor, in this example a digital signal processor (DSP) 52. The ADC is connected to the sensors 36, 38 using sine connection 54 and cosine connection 56.

The output of the ADC is connected to observer 44 within DSP 52. A carrier generator 43 is arranged to supply a carrier signal to the observer 44.

Observer 44 is an angle and speed observer which generates as output a measure of the angle and a measure of the speed of the rotor from the digitized sine and cosine signals. The observer may be of any type capable of outputting angle and speed signals. Alternatively, the observer may generate only the angle signal leaving the speed signal to be calculated elsewhere, for example in computing unit 46.

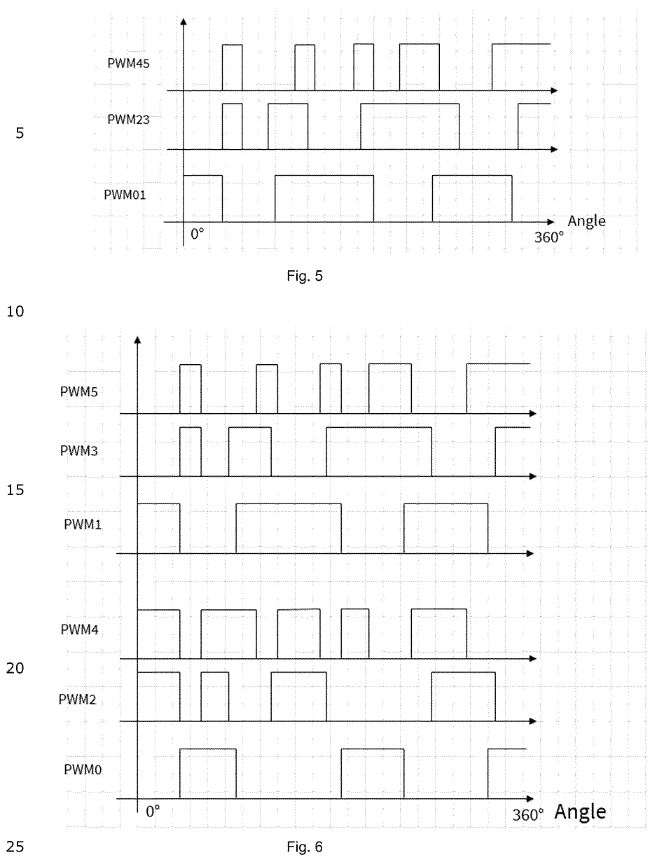

The angle output of observer 44 is connected to the look up table 48 which is a look up table of angle versus pulse output (see e.g. FIG. 5, below) and which outputs a pulse pattern signal, in this example a PWM signal simply looked up in the look up table based on the angle.

Timer output unit 50 is arranged to generate the actual high side and low side signals (see e.g. FIG. 6, discussed below) from the hardware digital signal taking into account the necessary dead time.

The calculating unit 46 is connected to the output of observer 44. A direct memory access unit 60 is also provided between the computing unit 46 and the look up table 48 as referred to below.

In use, the ADC 42 accepts the sine signal and the cosine signal from inductive sensors 36, 38 along sine connection 54, cosine connection 56 and digitizes them. The digital sine and cosine signal are then used in the angle observer 44 to generate an angle measurement which is passed in turn to the look up table 48 to generate the pulse pattern signal. This is then processed by timer unit 50 to generate the high side and low side driver signals.

The ADC module 42 can capture a sine and cosine signal relatively frequently, for example every 1 μs, every 2 μs or every 0.2 to 10 μs. The look up table 48 can generate the required output at a first rate, which may be simply the rate at which the sine and cosine signals are captured. This is possible as a look up table can generate an output quickly without requiring complex internal hardware structures.

It should be noted that as load conditions or the required drive of the motor 30 changes then different look up table patterns are required. Therefore, the look up table 48 has to be regularly updated. The computing unit 46 is arranged to use the angle and speed measurements, derived from the output of the observer 44, to select the best pattern for transfer. The DMA unit 60 is then instructed to automatically transfer the selected pattern into the look up table 48.

In this way, the look up table can be corrected regularly, though not as rapidly as the control loop of ADC module. The look up table may be updated at a second rate, for example every 20 μs, or every 50 μs or every 100 μs, for example at least five times slower than the first rate. The approach can deliver a high speed pulse pattern signal, in a particular example an OPP without the need the need for expensive hardware including in particular avoiding the need for high capacity high speed memory.

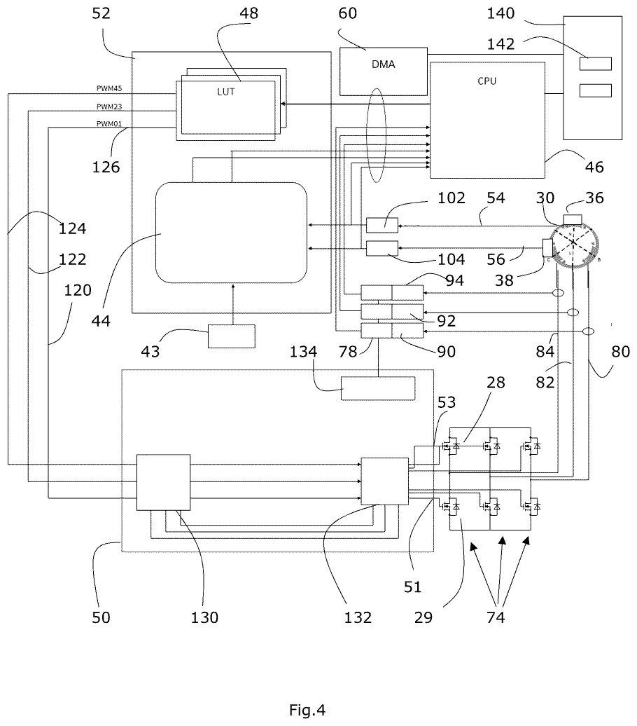

FIG. 4 illustrates an example using a motor driven using three phase currents, driven by a pulse pattern signal which in the example is a PWM signal, for example an OPP.

In this example, three half bridges 74 are provided in parallel, each with a high side transistor 28 and a low side transistor 29. These drive three respective current lines 80, 82, 84 which are connected to and drive motor 30.

Three current ADCs 90, 92, 94 are connected to respective current lines 80, 82, 84 to output a digital measure of the current. Each digital output is connected to an integrator 78 which provides a measure of smoothing.

The outputs of integrators 78 are connected to computing unit 46.

Sine connection 54 connects sensor 36 and ADC 102; cosine connection 56 connects sensor 38 and ADC 104.

In this case, three parallel look up tables 48 and an observer 44 are provided in DSP 52. The LUTs 48 each represent the PWM signal as a function of angle input for a respective one of the three half bridges 74. Each LUT is connected via a respective PWM output 126 to a respective PWM output line 120, 122, 124 which connects to the timer unit 50.

Timer unit 50 comprises a sampling unit 130 connected to the PWM output lines 120, 122, 124 and also having respective outputs. Timer unit 50 also comprises a timer 134. The output of timer 134 is used in timer unit 50 and also output to ADCs 90, 92, 94,102,104 and integrators 78 to maintain timing alignment.

A deadtime and inversion unit 132 has sampling inputs connected to sampling unit 130, in this embodiment one for each of the three respective PWM output lines, and provided with six outputs connected respectively to the six transistors of the half bridges 74, one output being connected to each respective transistor. For each half bridge there is provided an output pair having a negative side output 51 connected to drive the low side transistor 29 and a positive side output 53 connected to drive the high side transistor 28. In use, the deadtime and inversion unit 132 calculates the required output signals from the respective PWM signals obtained on the respective sampling inputs.

Note, in FIG. 4 the half bridges are shown schematically as being connected directly to the positive side outputs 53 and the negative side outputs 51 of timer unit 50. In examples, a driver circuit with a plurality of drivers (not shown) may be provided between the outputs 51, 53 and the half bridges 74 for example where the transistors of the half bridges require different drive characteristics to those available at the loop outputs 51.

In use, the look up table allows rapid generation of PWM signals without the need to involve the calculating unit 46.

A number of look up tables 142 are stored in memory 140.

The calculating unit 46 takes as inputs the outputs of integrators 78, representing the current values measured by ADCs 90, 92, 94, as well as the outputs of ADCs 102, 104 representing the sine and cosine signals, together with the outputs from observer 44 representing the angle and speed of the motor 30. The calculating unit may be a central processing unit for example or a parallel processing unit or other unit with a core capable of running instructions.

With this information the calculating unit 46 identifies which of the pre-stored look up tables 142 should be used at any given time, and outputs a signal to DMA 60 which downloads the identified look-up table in the look up tables 48 stored in the DSPs.

The pattern identification and adoption by main calculation unit is mostly defined by the speed and acceleration, but also environmental measurements like temperature of the system may lead to pattern recalculation or adoption based on the used approach for the motor performance metrics optimization.

By using this approach, OPP operation can be achieved without using high cost components, but still maintaining very fast and accurate angle to pattern relationship.

Referring to FIG. 5 each of the three graphs represents the PWM signal as a function of angle. This is the data that is stored in the look up table. Each graph corresponds to one of the half bridges 74.

After processing in the timer unit, these three graphs result in six drive signals for the six transistors, the high side transistor and low side transistor of a first half bridge (PWM 4 and PWM 5), the high side transistor and the low side transistor of a second half bridge (PWM2 and PWM 3) and the high side transistor and low side transistor of a third half bridge (PWM 0 and PWM 1). These are based on the respective PWM signal but a small amount of dead time is introduced.

The proposed method is not limited to bridge structure incorporating only 6 power transistors known as “B6” structures, the proposed method can be used for any inverter structure like multilevel inverter with other numbers of power transistors, for example more than 6 power transistors. The number of HW lines from the DSP(s) 52 to the timer must correspond to the independent number of power switches, or.

In the example of FIG. 4, three separate PWM output lines 120, 122, 124 are used, together with three separate look up tables 48. In an alternative example, a single PWM output line 120 is used to transfer multiple PWM signals. An example will now be described using this alternative.

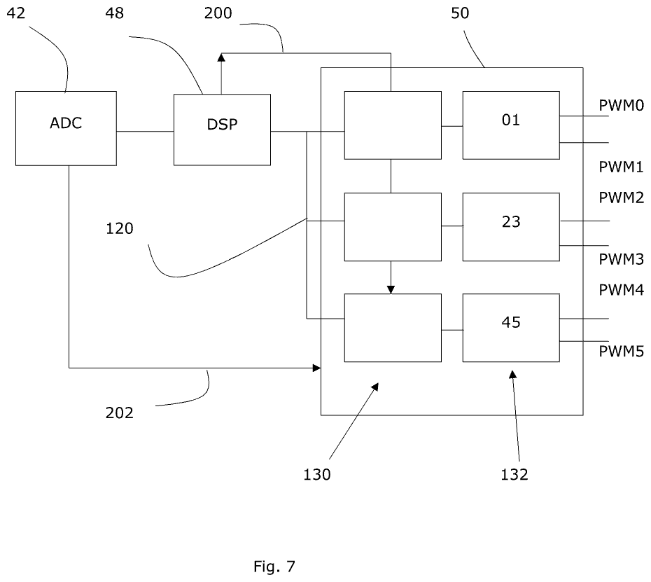

Referring to FIG. 7, a sampling time service request link 200 is provided in parallel to the PWM output line 120 between DSP 52 and timer unit 50. In addition, a synch service request link 202 is provided from ADC 42 again to timer unit 50.

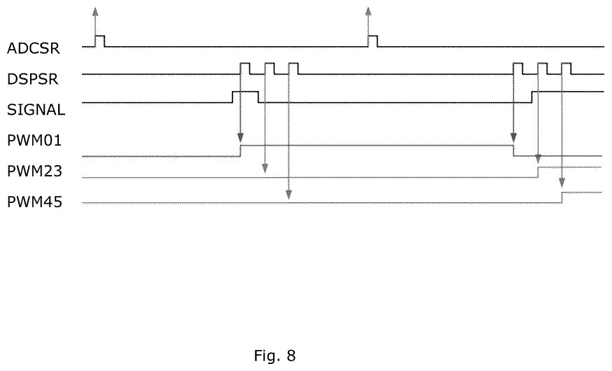

Referring to FIG. 8, the ADC 42 signals a service request (ADCSR) on synch service request link 202 to indicate that a new digital signal has been captured.

Shortly thereafter the DSP evaluates the required outputs using look up tables 48. The DSP sets the output on PWM output line 120 to correspond to output for first half bridge 01, and then triggers a service request on DSPSR to signal that the timer unit should capture the signal on PWM output line 120. Then, the PWM output line 120 is set to the level for second half bridge B, and a second service request (DSPSR) on sampling time service request link 200 is signaled, to indicate that the timer unit 50 should capture the signal on PWM output line 120 which now corresponds to the PWM signal for the second half bridge 23. This is then repeated one more time, with the signal on PWM output line 120 set to the level for third half bridge C and a third service request (DSPSR) sent on sampling time service request link 200 to indicate that the timer should capture the third PWM value for half bridge 45.

In the example of FIG. 8, in the first cycle the PWM value is high for the first half bridge 01 and low for the second and third half bridges 23 and 45.

The next cycle begins when ADC 42 captures a new digital signal and signals this by a new service request ADCSR on synch service request link 202. Again, the three PWM levels are sent down single PWM output line 120 using the synch signal DSPSR on synch service line 200 to indicate the timings of the signals for the three half bridges 01, 23 and 45.

In the example illustrated, in this case half bridge 01 has a low value and half bridges 23 and 45 have a high value.

These are sampled by sampling units 130 corresponding to each half bridge, and then deadtime and inversion units 132 generate the individual signals PWM0 and PWM1 for the first half bridge, PWM2 and PWM3 for the second half bridge and PWM4 and PWM5 for the third half bridge.

By using the synch service request ADCSR from ADC 42 to define the new period of transition and the service request DSPSR from the DSP 52 to signal to the timer unit that the current output value of the hardware line 120 is now valid for the corresponding output transmission of three PWM signals for the respective half bridges 74 is possible using just one line 120.

Further, note that although the service requests ADCSR and DSPSR are illustrated as travelling on dedicated hardware lines 200, 202 it is possible to send such signals over pre-existing buses or lines.

Note that although the embodiments of FIGS. 4 to 7 have been described with reference to PWM signals the method is generally applicable to generating pulse patterns including in particular examples optimized pulse patterns.
In an example there is provided a semiconductor device for generating a pulse pattern, signal, comprising: an analog to digital converter, ADC, for connection to a motor, having an output for indicating the angle of the motor, a coprocessor having an angle input connected to the output of the ADC, an observer connected to the angle input for determining a motor angle, a coprocessor look up table for generating a PWM pulse pattern signal as a direct function of the determined motor angle, and a pulse pattern signal output for outputting the pulse pattern signal, and a calculating unit having an input connected to the coprocessor, the calculating unit being arranged to select a look up table from a plurality of look up tables based on the determined motor conditions e.g. like acceleration and torque and to store the selected look up table as the coprocessor look up table in the coprocessor. The example may further comprise a memory storing the plurality of look up tables and a direct memory access device (DMA) unit for loading a look up table selected by the calculating unit directly into the coprocessor as the coprocessor look up table. In the example, the observer may comprise a loop output connected to the calculating unit, arranged to further determine a motor speed; to output the determined motor speed and the determined motor angle through the loop output to the calculating unit; and to output the angle to the look up table; wherein the calculating unit may be arranged to select the look up table based on the determined motor angle and the determined motor speed.

The look up table may be arranged to generate the pulse pattern signal at a first rate, and the calculating unit may be arranged to select the pulse pattern signal at a second rate, wherein the second rate is at least five times slower than the first rate.

The example may further comprise a timer unit connected to the pulse pattern signal output of the coprocessor, the timer unit having an input connected to the pulse pattern signal output of the coprocessor, and a positive side output and a negative side output for outputting high side and low side pulse pattern signals for driving a half bridge.

The example may be for driving an inverter for a three phase motor, the inverter having three half bridges, the timer unit comprising three output pairs for driving respective half bridges, each output pair comprising a positive side output and a negative side output.

The semiconductor device may comprise three look up tables in parallel, each look up table being for generating a respective PWM signal as a direct function of the generated motor angle, and three pulse pattern signal outputs in parallel for outputting the pulse pattern signal to a respective timer unit. The semiconductor device may further comprise a sampling time service request link from the coprocessor to the timer unit; whereby the coprocessor may be arranged to generate a plurality of pulse pattern signals, to output the plurality of pulse pattern signals sequentially on the pulse pattern signal output and to output a signal on the sampling time service request link to signal to the timer unit when a pulse pattern output signal is available on the pulse pattern signal output.

The timer unit may contain a sampling unit having an input connected to the pulse pattern output of the coprocessor to sample the pulse pattern signal on the pulse pattern signal output when indicated on the sampling time service request link, and a deadtime and inversion unit comprising an sampling input connected to the output of the sampling unit, further comprising the positive side output unit and the negative side output unit. For each output pair, the deadtime and inversion unit being arranged to generate the high side and low side pulse pattern signals on the positive side output unit and the negative side output unit respectively from the signal on the sampling signal input.

The example may further comprise a synch service request link from the ADC to the timer unit for signaling the presence of new digitized data captured by the ADC.

In an example, there is provided a system comprising a semiconductor device according to any of the previous examples and at least one half-bridge each containing a high side transistor connected to a positive side output of the semiconductor device and a low side transistor connected to a low side output of the semiconductor device.

In another example there is provided a method of generating a pulse pattern signal, comprising digitizing a signal representing an angle of a motor, determining a motor angle from the digitized signal using an observer; using a look up table to generate a pulse pattern signal as a direct function of the generated motor angle and outputting the pulse pattern signal, and selecting in a calculating unit a look up table based on the determined motor conditions e.g. like acceleration and torque and storing the selected look up table as the look up table.

The method may further include generating a motor speed using the observer and outputting the motor speed to the calculating unit.

The method may further include generating a high side signal and a low side signal for driving a half bridge form the pulse pattern signal and driving the half bridge with the high side signal and the low side signal. The method may include driving an inverter for a three phase motor, the inverter having three half bridges, the method comprising using three look up tables to generate three respective pulse pattern signals each as a direct function of the generated motor angle and outputting the pulse pattern signals.

The method may further include outputting the plurality of pulse pattern signals sequentially on a pulse pattern signal output and outputting a signal on a sampling time service request link to signal when a pulse output signal is available on the pulse pattern signal output.

The method may include generating the pulse pattern signal at a first rate, and selecting the pulse pattern signal at a second rate, wherein the second rate is at least five times slower than the first rate.

Although specific embodiments/examples/aspects have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the examples as outlined in the present document may be used stand-alone or in combination with the other methods and systems disclosed in this document. In addition, the features outlined in the context of an apparatus are also applicable to a corresponding method, and vice versa. Furthermore, all aspects of the methods and apparatus outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. A semiconductor device for generating a pulse pattern, signal, comprising:
an analog to digital converter, ADC, for connection to a motor, having an output for indicating the angle of the motor,
a coprocessor having an angle input connected to the output of the ADC, an observer connected to the angle input for determining a motor angle, a coprocessor look up table for generating a pulse pattern signal as a direct function of the determined motor angle, and a pulse pattern signal output for outputting the pulse pattern signal, and
a calculating unit having an input connected to the coprocessor, the calculating unit being arranged to select a look up table from a plurality of look up tables based on the determined motor conditions e.g. like acceleration and torque and to store the selected look up table as the coprocessor look up table in the coprocessor.

2. A semiconductor device according to claim 1, further comprising
a memory storing the plurality of look up tables and
a direct memory access device (DMA) unit for loading a look up table selected by the calculating unit directly into the coprocessor as the coprocessor look up table.

3. A semiconductor device according to claim 1 or 2,
wherein the observer comprises a loop output connected to the calculating unit, and is arranged:
to further determine a motor speed;
to output the determined motor speed and the determined motor angle through the loop output to the calculating unit; and
to output the angle to the look up table;
wherein the calculating unit is arranged to select the look up table based on the determined motor angle and the determined motor speed.

4. A semiconductor device according to any preceding claim, wherein
the look up table is arranged to generate the pulse pattern signal at a first rate, and
the calculating unit is arranged to select the pulse pattern signal at a second rate, wherein the second rate is at least five times slower than the first rate.

5. A semiconductor device according to any preceding claim, further comprising:
a timer unit connected to the pulse pattern signal output of the coprocessor, the timer unit having:
an input connected to the pulse pattern signal output of the coprocessor, and a positive side output and a negative side output for outputting high side and low side pulse pattern signals for driving a half bridge.

6. A semiconductor device according to claim 5 for driving an inverter for a three phase motor, the inverter having three half bridges, the timer unit comprising three output pairs for driving respective half bridges, each output pair comprising a positive side output and a negative side output.

7. A semiconductor device according to claim 5, comprising:
three look up tables in parallel, each look up table being for generating a respective PWM signal as a direct function of the generated motor angle, and
three pulse pattern signal outputs in parallel for outputting the pulse pattern signal to a respective timer unit.

8. A semiconductor device according to claim 6 or 7, wherein the semiconductor device further comprises:
a sampling time service request link from the coprocessor to the timer unit;
whereby the coprocessor is arranged to generate a plurality of pulse pattern signals, to output the plurality of pulse pattern signals sequentially on the pulse pattern signal output and to output a signal on the sampling time service request link to signal to the timer unit when a pulse pattern output signal is available on the pulse pattern signal output.

9. A semiconductor device according to claim 8, wherein the timer unit contains:
a sampling unit having an input connected to the pulse pattern output of the coprocessor to sample the pulse pattern signal on the pulse pattern signal output when indicated on the sampling time service request link, and
a deadtime and inversion unit comprising an sampling input connected to the output of the sampling unit, further comprising the positive side output unit and the negative side output unit. for each output pair, the deadtime and inversion unit being arranged to generate the high side and low side pulse pattern signals on the positive side output unit and the negative side output unit respectively from the signal on the sampling signal input.

10. A semiconductor device according to claim 8 or 9, further comprising
a synch service request link from the ADC to the timer unit for signaling the presence of new digitized data captured by the ADC.

11. A system comprising:
a semiconductor device according to any preceding claim; and
at least one half-bridge each containing a high side transistor connected to a positive side output of the semiconductor device and a low side transistor connected to a low side output of the semiconductor device.

12. A method of generating a pulse pattern signal, comprising:
digitizing a signal representing an angle of a motor,
determining a motor angle from the digitized signal using an observer;
using a look up table to generate a pulse pattern signal as a direct function of the generated motor angle and outputting the pulse pattern signal, and
selecting in a calculating unit a look up table based on the determined motor conditions e.g. like acceleration and torque and storing the selected look up table as the look up table.

13. A method according to claim 12, further comprising generating a motor speed using the observer and outputting the motor speed to the calculating unit.

14. A method according to claim 12 or 13 further comprising:
generating a high side signal and a low side signal for driving a half bridge form the pulse pattern signal and driving the half bridge with the high side signal and the low side signal.

15. A method according to claim 12, 13 or 14 for driving an inverter for a three phase motor, the inverter having three half bridges, the method comprising:
using three look up tables to generate three respective pulse pattern signals each as a direct function of the generated motor angle and outputting the pulse pattern signals.

16. A method according to claim 15, further comprising outputting the plurality of PWM signals sequentially on a pulse pattern signal output and outputting a signal on a sampling time service request link to signal when a pulse pattern output signal is available on the pulse pattern signal output.

17. A method according to any of claims 12 to 16, comprising
generating the pulse pattern signal at a first rate, and
selecting the pulse pattern signal at a second rate, wherein the second rate is at least five times slower than the first rate.
